(19) United States
(12) Patent Application Publication
(10) Pub. No.: US 2025/0297508 A1
(43) Pub. Date: Sep. 25, 2025

(54) SYSTEM AND METHOD FOR CASTELLATED EXTRUDED MULLION

(71) Applicant: Innovation Glass, LLC, Tivoli, NY (US)

(72) Inventor: Franz Safford, Tivoli, NY (US)

(73) Assignee: Innovation Glass, LLC, Tivoli, NY (US)

(21) Appl. No.: 19/088,026

(22) Filed: Mar. 24, 2025

Related U.S. Application Data
(60) Provisional application No. 63/569,389, filed on Mar. 25, 2024.

(51) Int. Cl. E06B 3/14; B21C 25/10

(52) U.S. Cl. CPC E06B 3/14; B21C 25/10

(57) ABSTRACT

An aluminum mullion and method for creation by an extrusion and castellation process for use in a construction section. The aluminum mullion may comprise a first end, a second end having a guide track; a height, and a mullion body positioned between the first end and the second end. The aluminum mullion may be extruded by pushing semi-molten aluminum through a steel die under high pressure to create a monolithic beam shape and then at least one portion of the mullion body is removed by the castellation process. Multiple portions of the mullion body may be removed along the height of the mullion as needed for construction requirements.

### BACKGROUND OF THE TECHNOLOGY

This application claims the benefit of U.S. Provisional Application Ser. No. 63/569,389 filed Mar. 25, 2024, which is hereby incorporated by reference herein in its entirety

### BACKGROUND OF THE TECHNOLOGY

A variety of systems are used in the construction of buildings. Many of these systems employ a framework, such as in the case of conventional point-supported and conventional glass wall systems. In these systems, panes of glass are attached to, and supported by horizontal and vertical mullions. The process of fabrication and material used for the mullions may contribute to increased support capabilities, longer lasting components, and decreased weight.

### SUMMARY OF THE TECHNOLOGY

A system and method for the fabrication of high span mullions for the support of construction sections. The system may generally include a method of fabricating a mullion utilizing an extrusion and castellation process.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1A representatively illustrates an isometric view of a solid mullion that has been extruded and castellated in accordance with an exemplary embodiment of the present technology;

FIG. 1B representatively illustrates an enlarged isometric view of FIG. 1A of a solid mullion that has been extruded and castellated in accordance with an exemplary embodiment of the present technology;

FIG. 2A representatively illustrates an isometric view of a hollow mullion that has been extruded and castellated in accordance with an exemplary embodiment of the present technology;

FIG. 2B representatively illustrates an enlarged isometric view of FIG. 2A of a hollow mullion that has been extruded and castellated in accordance with an exemplary embodiment of the present technology;

FIG. 3 representatively illustrates a cross-section view of a solid mullion of FIGS. 1A and 1B that has been extruded and castellated with a fitting attached thereto and supporting a glass panel in accordance with an exemplary embodiment of the present technology;

FIG. 4 representatively illustrates a cross-section view of a hollow mullion of FIGS. 2A and 2B that has been extruded and castellated with a fitting attached thereto and supporting a glass panel in accordance with an exemplary embodiment of the present technology;

FIG. 5 representatively illustrates an isometric view of the hollow mullion of FIGS. 2A and 2B that has been extruded and castellated with a fitting attached thereto for supporting a glass panel in accordance with an exemplary embodiment of the present technology; and

FIG. 6 representatively illustrates a side view of the hollow mullion of FIGS. 2A and 2B that has been extruded and castellated with a pair of fittings attached, supporting a glass panel, and coupled to a building structure in accordance with an exemplary embodiment of the present technology.

### DETAILED DESCRIPTION OF THE DRAWINGS

The present technology may be described in terms of functional block components and various processing steps. Such functional blocks may be realized by any number of components configured to perform the specified functions and achieve the various results. For example, the present technology may employ various types of mullions, guide tracks, fittings, hangers, fasteners, spacers, glass panels, walls, and the like, which may carry out a variety of functions. Further, the present technology may employ any number of components for a point supported construction system for supporting a glass panel.

Various representative implementations of the present technology may be applied to any system for construction. Certain representative implementations may include systems and methods tailored to a specific type of construction, such as mullions for point-supported glass wall systems.

In general point-supported glass wall systems utilize fittings connected with mullions to provide support for various types of construction sections. A mullion refers to a vertical or horizontal bar that divides and supports sections of windows, doors, or other types of openings. Mullions are crucial components in architectural design and are commonly used in both residential and commercial construction projects. Mullions are generally oriented perpendicular to the exterior surface of the building/wall/glass panel which they support. As such, a standard mullion generally has a flat, planar surface that is generally perpendicular to the longitudinal centerline of the mullion and parallel to the exterior surface of the building/wall/glass panel that it supports. The fitting(s) may be attached to a mullion and the construction section or glass panel is supported by the fitting(s). The fitting(s) may be attached to the flat, planar surface of the mullion and the exterior surface of the building/wall/glass panel supported by the fitting is oriented generally perpendicular to the longitudinal centerline of the mullion.

When a construction section reaches a length or height of over 25 feet, conventional mullions typically must be made from steel to accommodate the support requirements for the construction section. Specifically, long span façade mullions have problems when the wall height spans a dimension of 25 feet and higher require special structural solutions to achieve the high span. These special structural conditions usually preclude the use of conventional aluminum curtain walls which have spanning limits typically of only +/−15 feet. Some types of conventional aluminum curtain walls can be reinforced to achieve wall heights spanning up to 25 feet spans but the modifications to achieve the support requirements typically are not cost effective. As such, when the dimensions of the curtain wall are above 25 feet, using steel framing for the mullion is the current standard practice. Steel framing typically uses the “built up” process where outer and inner chords are welded to web members, which connect the chords to create the mullion and provide with the needed load bearing characteristics. However, the use of steel framing has many detrimental characteristics for facades including high cost as compared to aluminum curtain walls, higher weight, poor tolerances, rough surface finish appearance and vulnerability to rust corrosion over time in the presence of moisture. The use of extensive steel interior steel reinforcement to bear the added stresses of the higher spans is expensive and difficult to insert inside the conventional aluminum members rendering them very heavy.

Typically, the steel material for steel framing is produced by a rolling process, which creates residual stresses in the material after it is rolled. When fabricating steel in the form of cutting and welding, residual stresses are released resulting in warping of the steel beam member during fabrication. In other words, when steel is welded it bows due to unbalanced stress relief in the steel material. The steel material cools from the outside in with the inside being at a much higher temperature than the surface. This difference in temperature and hence solidification of the material after rolling sets up internal stresses in the layers of the material. These stresses “release” when the material is worked during fabrication: welding, bending, cutting. So when a castellated mullion is created by assembling plates and sections and welding them together (“built-up”) the heat from the welding process ends up bowing the end product in various directions. When using the “built-up” process, a meticulous and involved post fabrication process is needed to try to straighten the assembled steel mullion, which is accomplished with presses and heating the metal up selectively

It is impossible to completely eliminate this warping of the steel mullion, which results in the finished steel mullion member having large tolerance variations and causes problems when attaching glass glazing systems which are high tolerance. The solution to the steel mullion not being straight is to make the attachments points between the steel mullion and the curtain wall to allow for the tolerance variation of steel mullion. These attachments points tend to be quite bulky and unsightly detracting from the aesthetic of the finished wall. The attachments points, however, are needed when using a steel mullion so the architects and owners reluctantly accept them.

Another downside to using a steel mullion is steel rusts when it is exposed to moisture, so the steel mullion must be painted. However, steel has an inherent surface roughness as a material trait so when paint is applied to the surface the finished product has a textured surface appearance, which is not generally desirable for high end interiors of buildings. For improved steel finish quality one must perform a rigorous preparation process that involves sanding the entire surface of the mullion, filling in the surface imperfections with body puddy, sanding it smooth, and then painting it. Even with the rigorous process, the paint finish is never as smooth as paint on extruded aluminum mullion.

As such, utilizing an aluminum mullion that may span above 25 feet would be preferable to a steel mullion. An extruded castellated aluminum mullion or a built-up mullion may be used for wall height spans above 25 feet. However, a built-up mullion requires utilizing multiple aluminum components and assembling them into a truss beam by welding or bolting them together. This built-up mullion process is also not cost effective and requires more time for assembly. Additionally, welding aluminum reduces the allowable design stress by 50% in the weld affected zone decreasing the capacity of the assembled truss resulting in the need to add material to compensate; this increases the cost of a welded built-up aluminum truss.

The aluminum mullion made by an extrusion and castellations process costs less than a steel mullion and a built-up mullion. The extruded castellated aluminum mullion is capable of being produced with much higher tolerances than that of steel. The internal stresses that are present with the rolled steel mullions are not present in an extrusion process. The result is that the extruded castellated aluminum mullions are much straighter than the steel versions allowing for minimal sizing of the connections to a glass wall. In other words, the tolerance of the finished extruded castellated aluminum mullions is equivalent with that of the glass tolerances so the two mate up well.

Further, the extruded castellated aluminum mullion has a smooth, high quality surface finish, and eliminates rust corrosion even if the metal is located on an exterior of the glass façade. Still further the cost savings of using an extruded castellated aluminum mullion rather than a steel mullions are within the 30-50% range, which on large jobs can result in high cost savings for the builder and owners of the project.

The extrusion of the aluminum is conducted by pushing semi-molten aluminum through a steel die under high pressure to create a monolithic beam shape. A separate die is used for each desired shape of a mullion. No welding or assembly is required to achieve the beam assembly after the extrusion process is complete. It should be noted that some minor fabrication is required, such as, drilling holes to anchor the beams/mullion channels.

The extrusion process greatly simplifies the fabrication requirements resulting in a lower cost of the final product. The use of aluminum material as opposed to steel allows for a much smoother high quality painted finish to be achieved because the molecular structure of the aluminum surface is denser than steel resulting in a smoother appearance. Because aluminum does not rust or corrode, the use of aluminum in lieu of steel eliminates the risk to the user, greatly reducing operational maintenance costs.

The use of the aluminum extrusion process eliminates the residual stress issue. Aluminum extrusions do not have residual stresses because the metal is produced in a semi-molted state that does not create stresses in the finished product. Further, the aluminum extrusion process allows for very high tolerances to be achieved in the finished product. Additionally, warping is almost completely eliminated allowing accurate interfacing with the glass cladding.

Once the extruded aluminum beam/mullion is created, a post-extrusion fabrication process called castellation is utilized to remove certain web material between the inner and outer chords of the extruded shape creating a “castellated” beam/mullion assembly.

Using aluminum rather than steel for these mullions has many additional advantages. The extruded castellated aluminum mullions weigh less than steel allowing the supporting structure to be reduced, thereby saving cost. Additionally, the lighter weight makes it easier to install the extruded castellated aluminum mullion in the field, thereby reducing cost. The extrusion process may also allow the integration of channels, reveals, and/or void areas into the chords of the extruded castellated aluminum mullion allowing for the integration of recessed lighting. Still further, the shape of the extruded castellated aluminum mullion can be modified in infinite variations because the extrusion process involves a die which defines the shape of the extruded castellated aluminum mullion. The die can be produced with infinite variations in shape, which gives the designer and owner great flexibility in selecting an appropriate shape of the mullion to complement their overall building design. The glazing attachment details can be integrated into the die shape simplifying the manner in which the glass cladding attaches to the final product, thereby reducing material and labor costs.

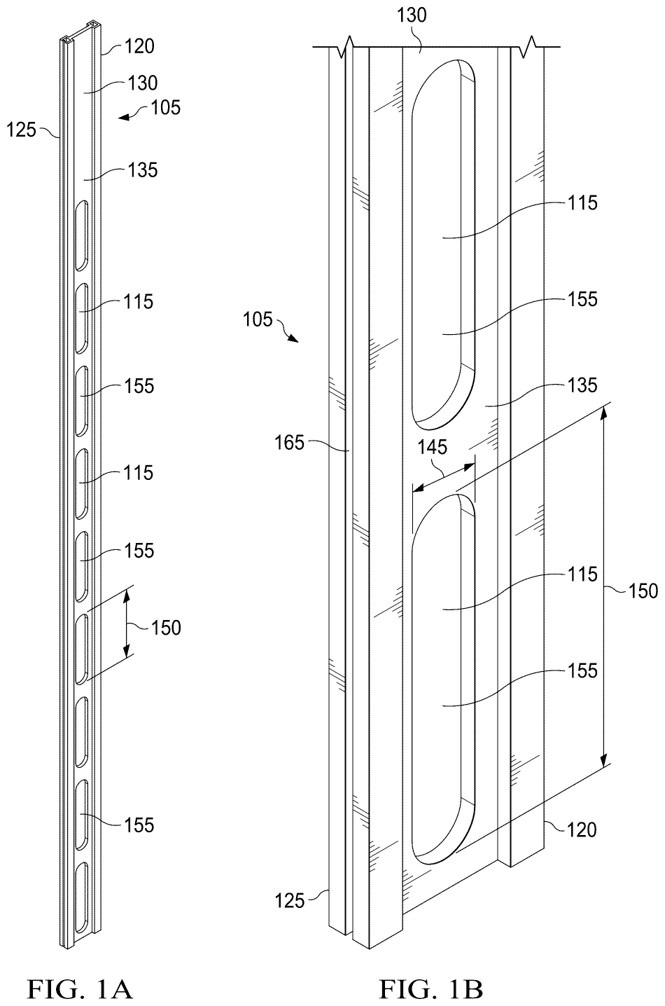

Referring now to FIGS. 1-4, a construction system 100 generally comprises an extruded castellated aluminum mullion 105 and a fitting 110. The extruded castellated aluminum mullion 105 is generally configured for engagement with the fitting 110 and provides support for a construction section and/or glass panel held in place by the fitting 110. The extruded castellated aluminum mullion 105 may comprise any structural or design features that may be employed to allow for the attachment of the fitting(s) 110 for providing support and/or retention of construction sections. The construction sections may comprise wood, ceramic, glass, glass panels, polymer sheeting, bullet-proof glass, synthetic paneling, and the like.

The extruded castellated aluminum mullion 105 may be fabricated using aluminum in an extrusion and castellation process. In one embodiment, the extruded castellated aluminum mullion 105 may be fabricated from extruded aluminum and then castellated to provide the optimal design.

To construct the extruded castellated aluminum mullion 105, the aluminum is extruded by pushing semi-molten aluminum through a steel die under high pressure to create a monolithic beam shape. Once the beam is constructed, at least one portion 115 of the beam is removed by a castellation process.

The mullion 105 may comprise a first end 120 that may be positioned towards the interior of a structure being constructed and a second end 125 configured to be coupled to the fitting 110. A mullion body 130 is located between the first end 120 and the second end 125 of the mullion 105.

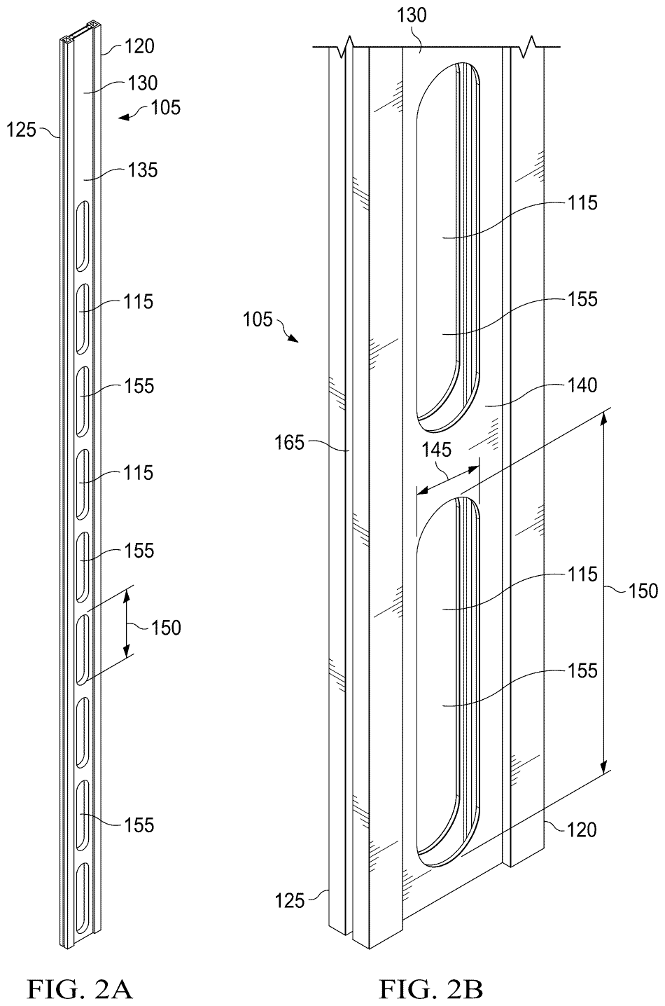

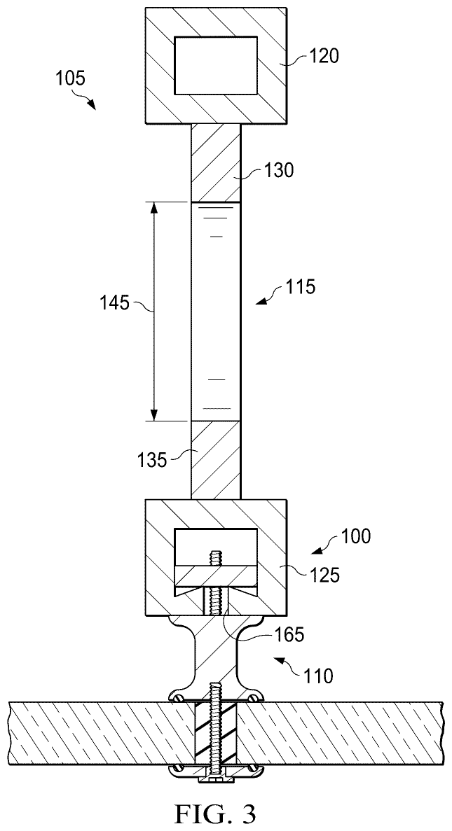

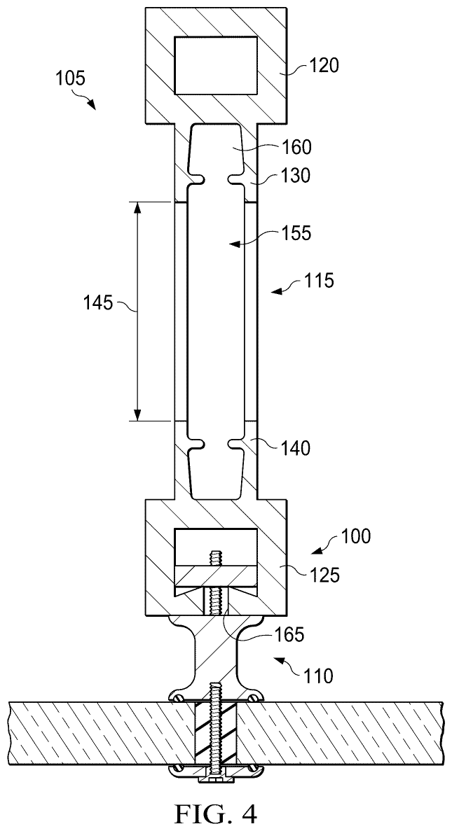

FIGS. 1A, 1B, and 3 show an extruded castellated aluminum mullion 105 with a solid body 135, typically referred to as a “web” when describing trusses, with a portion 115 of the beam removed. The solid body 135 is a castellated extruded truss with a solid web. FIGS. 2A, 2B and 4 shows an extruded castellated aluminum mullion with a hollow body 140 with a portion 115 of the beam removed. The hollow body 140 is a castellated extruded truss with two web members in parallel with a gap between them resulting in the hollow body. The portion 115 removed is shown by the castellation width 145 and castellation height 150. The amount removed will depend on the requirements of the design of the façade. The removal of the portion 115 of the metal during the castellation process creates a void space 155 that reduces the weight of the extruded castellated aluminum mullion 105 and allows the extruded castellated aluminum mullion 105 to be visually more transparent. The castellation process may include milling, laser cutting, water jet cutting and the like.

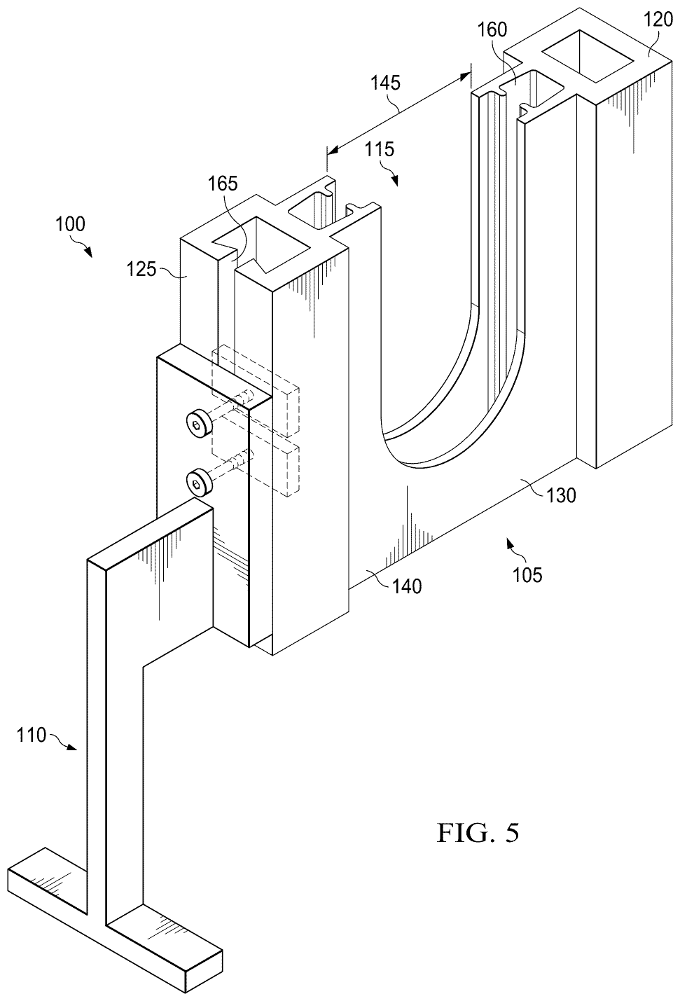

The extruded castellated aluminum mullion 105 shown in FIGS. 2, 2B and 4-6 generally comprises a structure having one or more void cavities 160 and a guide track 165. The cavity 160 may be of any volume or shape and may be disposed within any part of the mullion 105. For example, the mullion 105 may comprise a plurality of cavities with intervening structures between the void cavities 160, for example, in order to increase the load bearing strength of the mullion 105.

The guide track 165 may be disposed along at least one dimension of the mullion 105. The guide track 165 may be disposed along a substantially linear length of the mullion 105 and may be suitably adapted for adjustable engagement with the fitting 110. The fitting 110 may be adjusted along the guide track 165 and substantially fixed in place at any point along the guide track 165. The fitting 110 may be suitably configured to support any type of construction section, such as a pane of glass or glass panel 170.

The fittings discussed herein are disclosed in U.S. Pat. No. 8,973,316 and U.S. patent application Ser. No. 18/591,247, the content of which are incorporated by reference. The shapes and configuration of portions of the mullions discussed therein are also incorporated by reference.

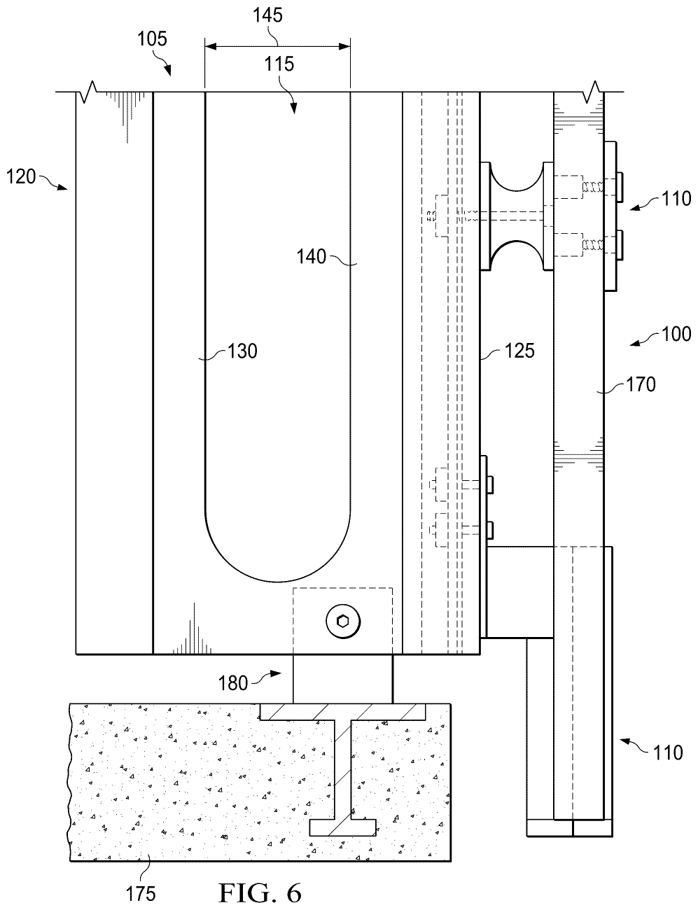

As shown in FIG. 6, the structure of the extruded castellated aluminum mullion 105 allows it to support the weight of the construction section or glass panel 170 held by the fittings 110. Additionally, the extruded castellated aluminum mullion 105 may permit translational or rotational motion in response to environmental effects, such as wind, rain and/or thermal expansion or contraction.

The extruded castellated aluminum mullion 105 may connect with any suitable structures, systems and devices in any suitable manner to achieve any particular purpose. The extruded castellated aluminum mullion 105, be configured for attachment to a surface such as a structure of a building 175, including a floor, wall and/or the like. The extruded castellated aluminum mullion 105 may be attached to any suitable surface in any suitable manner, such as by fasteners 180, and may be configured to support any structure, system, device or architectural element in any suitable manner. For example, the structure of the extruded castellated aluminum mullion 105 may comprise the guide track 165 that operates with the fitting 110 to provide attachment and support for glass panels 160.

In a construction system according to various aspects of the present technology, extruded castellated aluminum mullion 105 may be attached to the structure of a building 175 to provide a framework for supporting construction sections. Suitably configured fittings 110 may be attached to the extruded castellated aluminum mullion 105 to provide point-supported or continuously supported retention of construction sections. Construction systems in accordance with various exemplary embodiments of the present technology may be used to build any type of structure, such as a point-supported glass wall 170, for example. The construction system may also be used to achieve various aesthetic benefits. For example, the panes of glass used to form a glass wall will generally be displaced away from the mullions, making it more difficult to see the extruded castellated aluminum mullion 105 from an exteriorly disposed vantage point. Additionally, construction systems in accordance with the present technology may be used to achieve any structural benefit, whether now known or hereafter described in the art, such as the ability to construct a multi-story point-supported glass wall system using substantially vertically-aligned extruded castellated aluminum mullions.

Constructs (i.e., construction designs) that may be realized via implementation of various embodiments of the present technology shall be understood to comprise anything that may be at least partially assembled from at least one or more component parts, such as, for example: a window; a wall; a partition; a frame; a panel; a covering; a dome; a door; a display case; a display wall; a display frame; a cubicle; a presentation display; a booth; an enclosure; a temporary habitat; a mobile home; a video device array; various architectural construction elements; and/or the like.

A ‘construction section’ shall be understood to comprise any component part of a construct surface, such as, for example, a pane of glass, a panel of wood, a sheet of drywall, a graphite board, Plexiglas, Lucite, a video device element, etc. Furthermore, a construction section may comprise any two-dimensional (e.g., substantially planar) or three-dimensional (e.g., polyhedral, spherical, hemispherical, elliptical, parabolic, etc.) geometry and/or any combination thereof.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. An aluminum mullion created by an extrusion and castellation process for use in a construction section, the aluminum mullion comprising:
a first end;
a second end having a guide track;
a height; and
a mullion body positioned between the first end and the second end; and
wherein the aluminum mullion is extruded by pushing semi-molten aluminum through a steel die under high pressure to create a monolithic beam shape and then at least one portion of the mullion body is removed by a castellation process.

2. The aluminum mullion of claim 1, wherein the height of the aluminum mullion has a vertical length of over 25 feet.

3. The aluminum mullion of claim 1, wherein the at least one portion that is removed comprises a castellation height and a castellation width.

4. The aluminum mullion of claim 3, wherein the at least one portion that is removed creates a void space within the body to reduce the weight of the aluminum mullion.

5. The aluminum mullion of claim 4, wherein the at least one portion that is removed comprises multiple removed portions along the height of the aluminum mullion.

6. The aluminum mullion of claim 5, wherein mullion body has a solid web.

7. The aluminum mullion of claim 5, wherein mullion body has a hollow web.

8. The aluminum mullion of claim 7, wherein the hollow web comprises a pair of parallel members with a gap between the parallel members formed by the castellation process to create a void cavity.

9. The aluminum mullion of claim 8, wherein the portions are removed from the void cavity.

10. The aluminum mullion of claim 3, wherein the castellation width is a width between the first and second end of the aluminum mullion and the castellation height is a height between a top end and a bottom end of the aluminum mullion.

11. A method of constructing an aluminum mullion, the method comprising:
creating the aluminum mullion by pushing semi-molten aluminum through a steel die under high pressure to create a monolithic beam shape comprising a first end, a second end, a height, and a mullion body; and
removing at least one portion of the mullion body by a castellation process.

12. The method of claim 11, wherein the height of the aluminum mullion has a vertical length of over 25 feet.

13. The method of claim 11, wherein the at least one portion that is removed comprises a castellation height and a castellation width.

14. The method of claim 13, wherein the at least one portion that is removed creates a void space to reduce the weight of the aluminum mullion.

15. The method of claim 14, wherein the at least one portion that is removed during the castellation process comprises multiple removed portions along the height of the aluminum mullion.

16. The method of claim 15, wherein mullion body has a solid web.

17. The method of claim 15, wherein mullion body has a hollow web.

18. The method of claim 17, wherein the hollow web comprises a pair of parallel members with a gap between the parallel members formed by the castellation process to create a void cavity.

19. The method of claim 18, wherein the portions are removed from the void cavity.

20. The method of claim 13, wherein the castellation width is a width between the first and second end of the aluminum mullion and the castellation height is a height between a top end and a bottom end of the aluminum mullion.
